(19) United States
(12) Patent Application Publication
(10) Pub. No.: US 2023/0353209 A1
(43) Pub. Date: Nov. 2, 2023

(54) REPORTING CHANNEL STATE INFORMATION BASED ON A TRANSMISSION HYPOTHESIS

(71) Applicant: Lenovo (Singapore) Pte. Ltd., New Tech Park (SG)

(72) Inventors: Ahmed Monier Ibrahim Saleh Hindy, Aurora, IL (US); Vijay Nangia, Woodridge, IL (US)

(21) Appl. No.: 18/029,517

(22) PCT Filed: Sep. 30, 2021
(86) PCT No.: PCT/IB2021/058974

§ 371 Date: Mar. 30, 2023

Related U.S. Application Data
(60) Provisional application No. 63/087,127, filed on Oct. 2, 2020.

(51) Int. Cl. H04B 7/06; H04B 7/0456; H04L 1/00

(52) U.S. Cl. CPC H04B 7/0626; H04B 7/0456; H04B 7/0628; H04L 1/0026

(57) ABSTRACT

Apparatuses, methods, and systems are disclosed for reporting CSI based on a transmission hypothesis. One method includes receiving a CSI reporting configuration corresponding to TRPs. The method includes receiving at least one CSI reference signal resource based on the CSI reporting configuration. The method includes generating at least one CSI report corresponding to a transmission hypothesis. The at least one CSI report includes at least one CQI value; each hypothesis corresponds to a single TRP or multiple TRPs jointly transmitted from two TRPs, and a transmission configuration including two TCI states corresponds to the TRPs; the at least one CSI report is transmitted based on a CSI reporting trigger; and a number of CSI reports of the at least one CSI report is generated based on a UE capability of the UE.

### CROSS-REFERENCE TO RELATED APPLICATIONS

This application claims priority to U.S. Patent Application Ser. No. 63/087,127 entitled “APPARATUSES, METHODS, AND SYSTEMS FOR CSI ENHANCEMENTS FOR MULTI-TRP UNDER URLLC SCENARIOS” and filed on Oct. 2, 2020 for Ahmed Monier Ibrahim Saleh Hindy, which is incorporated herein by reference in its entirety.

### FIELD

The subject matter disclosed herein relates generally to wireless communications and more particularly relates to reporting channel state information based on a transmission hypothesis.

### BACKGROUND

In certain wireless communications networks, multi-TRP transmissions may require excessive control signaling. Excessive control signaling may result in lost transmissions and/or excessive data usage.

### BRIEF SUMMARY

Methods for reporting channel state information based on a transmission hypothesis are disclosed. Apparatuses and systems also perform the functions of the methods. One embodiment of a method includes receiving, at a user equipment, a channel state information reporting configuration corresponding to at least two transmission and reception points. In some embodiments, the method includes receiving at least one channel state information reference signal resource based on the channel state information reporting configuration. In certain embodiments, the method includes generating at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

One apparatus for reporting channel state information based on a transmission hypothesis includes a user equipment. In some embodiments, the apparatus includes a receiver that: receives a channel state information reporting configuration corresponding to at least two transmission and reception points; and receives at least one channel state information reference signal resource based on the channel state information reporting configuration. In various embodiments, the apparatus includes a processor that generates at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

Another embodiment of a method for reporting channel state information based on a transmission hypothesis includes transmitting, from a network device, a channel state information reporting configuration corresponding to at least two transmission and reception points. In some embodiments, the method includes transmitting at least one channel state information reference signal resource based on the channel state information reporting configuration. In certain embodiments, the method includes receiving at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

Another apparatus for reporting channel state information based on a transmission hypothesis includes a network device. In some embodiments, the apparatus includes a transmitter that: transmits a channel state information reporting configuration corresponding to at least two transmission and reception points; and transmits at least one channel state information reference signal resource based on the channel state information reporting configuration. In various embodiments, the apparatus includes a receiver that receives at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for reporting channel state information based on a transmission hypothesis;

FIG. 2 is a schematic block diagram illustrating one embodiment of an apparatus that may be used for reporting channel state information based on a transmission hypothesis;

FIG. 3 is a schematic block diagram illustrating one embodiment of an apparatus that may be used for reporting channel state information based on a transmission hypothesis;

FIG. 4 is a diagram illustrating one embodiment of ASN.1 code for a CSI-ReportConfig report setting information element;

FIG. 5 is a diagram illustrating another embodiment of ASN.1 code for a CSI-ReportConfig report setting information element;

FIG. 6 is a flow chart diagram illustrating one embodiment of a method for reporting channel state information based on a transmission hypothesis; and

FIG. 7 is a flow chart diagram illustrating another embodiment of a method for reporting channel state information based on a transmission hypothesis.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

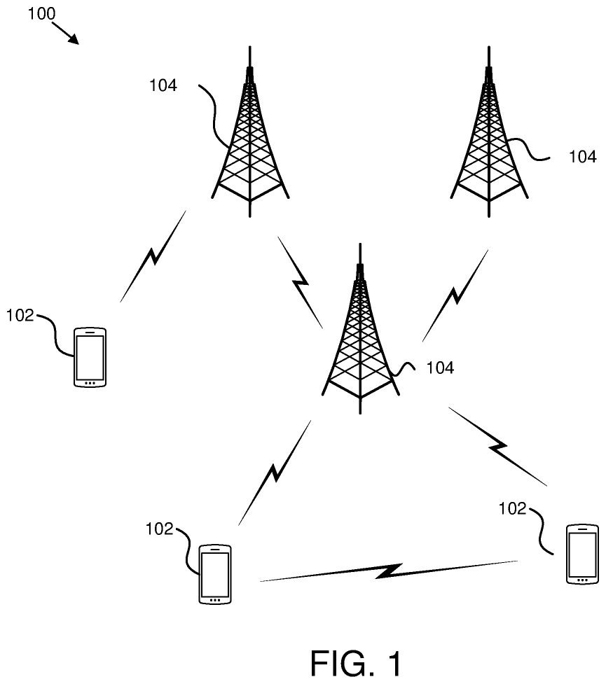

FIG. 1 depicts an embodiment of a wireless communication system 100 for reporting channel state information based on a transmission hypothesis. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a channel state information reporting configuration corresponding to at least two transmission and reception points. In some embodiments, the remote unit 102 may receive at least one channel state information reference signal resource based on the channel state information reporting configuration. In certain embodiments, the remote unit 102 may generate at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment. Accordingly, the remote unit 102 may be used for reporting channel state information based on a transmission hypothesis.

In certain embodiments, a network unit 104 may transmit a channel state information reporting configuration corresponding to at least two transmission and reception points. In some embodiments, the network unit 104 may transmit at least one channel state information reference signal resource based on the channel state information reporting configuration. In certain embodiments, the network unit 104 may receive at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment. Accordingly, the network unit 104 may be used for reporting channel state information based on a transmission hypothesis.

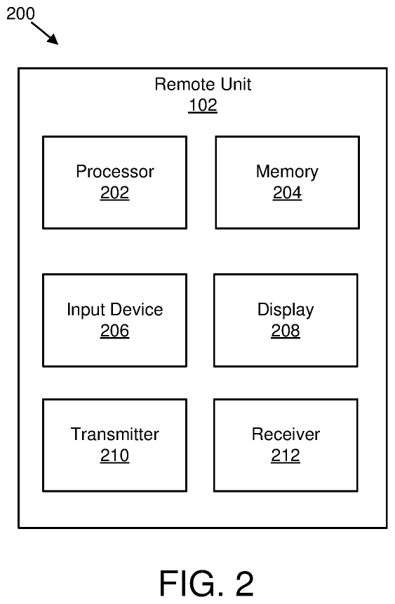

FIG. 2 depicts one embodiment of an apparatus 200 that may be used for reporting channel state information based on a transmission hypothesis. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212: receives a channel state information reporting configuration corresponding to at least two transmission and reception points; and receives at least one channel state information reference signal resource based on the channel state information reporting configuration. In various embodiments, the processor 202 generates at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

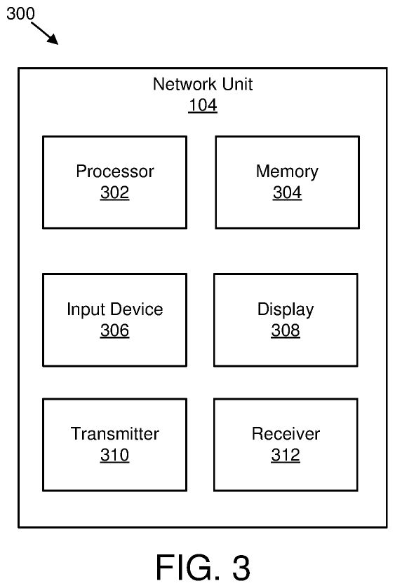

FIG. 3 depicts one embodiment of an apparatus 300 that may be used for reporting channel state information based on a transmission hypothesis. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310: transmits a channel state information reporting configuration corresponding to at least two transmission and reception points; and transmits at least one channel state information reference signal resource based on the channel state information reporting configuration. In various embodiments, the receiver 312 receives at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

In certain embodiments, such as for third generation partnership program (“3GPP”) new radio (“NR”), multiple transmission and reception points (“TRPs”) or multiple antenna panels within a TRP may communicate simultaneously with one user equipment (“UE”) to enhance coverage, throughput, and/or reliability. In such embodiments, this may comes at the expense of excessive control signaling between a network side and a UE side, to communicate a best transmission configuration (e.g., whether to support multi-point transmission), and if so, which TRPs would operate simultaneously, in addition to a possibly super-linear increase in an amount of channel state information (“CSI”) feedback reported from the UE to the network, since a distinct report may be needed for each transmission configuration. In some embodiments, such as with a Type-II codebook with high resolution, a number of precoding matrix indicator (“PMI”) bits fed back from the UE in a gNB via uplink control information (“UCI”) may be very large (e.g., >1000 bits at large bandwidth), even for a single-point transmission. In such embodiments, reducing the number of PMI feedback bits per report may be important to improve efficiency. In various embodiments, multiple input multiple output (“MIMO”) enhancements may be applied to multi-TRP and multi-panel transmissions. In certain embodiments, a purpose of multi-TRP transmission may be to improve spectral efficiency, and reliability and robustness of a connection (e.g., for ideal and nonideal backhaul). In some embodiments, to increase a reliability using multi-TRP, ultra-reliable low-latency communication (“URLLC”) under multi-TRP transmission may be used. In such embodiments, the UE may be served by multiple TRPs forming a coordination cluster, possibly connected to a central processing unit.

In various embodiments, a UE may be dynamically scheduled to be served by one of more TRPs in the cluster. In such embodiments, a network may pick two TRPs to perform joint transmission. Moreover, the UE may report needed CSI information for the network for it to decide a multi-TRP downlink transmission scheme.

In certain embodiments, a number of transmission hypotheses may increase exponentially with a number of TRPs in a coordination cluster. For example, for 4 TRPs, there are 10 transmission hypotheses: (TRP 1), (TRP 2), (TRP 3), (TRP 4), (TRP 1, TRP 2), (TRP 1, TRP 3), (TRP 1, TRP 4), (TRP 2, TRP 3), (TRP 2, TRP 4), and (TRP 3, TRP 4). The overhead from reporting may increase dramatically with the size of the coordination cluster.

In some embodiments, uplink transmission resources on which CSI reports are transmitted might not be enough, and partial CSI omission may be necessary. In such embodiments, CSI reports may be prioritized according to: 1) time-domain behavior and physical channel, where more dynamic reports are given precedence over less dynamic reports and physical uplink shared channel (“PUSCH”) has precedence over physical uplink control channel (“PUCCH”); 2) CSI content, where beam reports (e.g., layer 1 (“L1”) reference signal received power (“RSRP”) (“L1-RSRP”) reporting) has priority over regular CSI reports; 3) a serving cell to which the CSI corresponds (e.g., for carrier aggregation (“CA”) operation)—CSI corresponding to a primary cell (“PCell”) has priority over CSI corresponding to secondary cells (“Scells”); and 4) a report configuration identifier (“ID”) (e.g., reportConfigID).

In various embodiments, for the purpose of multi-TRP URLLC PDSCH transmission, a UE may be enabled to: 1) reduce a CSI reporting overhead without degrading performance; and/or 2) modify partial CSI omission priorities to favor multi-TRP transmission hypotheses with higher spectral efficiency.

In certain embodiments, one or more elements or features from one or more of embodiments herein may be combined, such as for CSI measurement, feedback generation, and/or reporting which may reduce the overall CSI feedback overhead.

For embodiments described herein, the term “TRP” may refer to one or more: 1) TRPs, panels, communication (e.g., signals and/or channels) associated with a control resource set (“CORESET”) pool, communication associated with a transmission configuration indicator (“TCI”) state from a transmission configuration including at least two TCI states. In some embodiments, a codebook type used may be arbitrary (e.g., different codebook types may be used such as Type-I and Type-II codebooks). In various embodiments, a single downlink control information (“DCI”) may be triggered by a network for a single TRP or multi-TRP scheme involving the transmission. In such embodiments, the multi-TRP scheme may be based on space-division multiplexing (“SDM”), frequency division multiplexing (“FDM”), and/or time division multiplexing (“TDM”).

In certain embodiments, a UE may be configured by higher layers with one or more CSI report configuration reporting settings (e.g., CSIReportConfig reporting settings) for CSI reporting, one or more CSI resource configuration resource settings (e.g., CSI-ResourceConfig resource settings) for CSI measurement, and one or two lists of trigger states (e.g., given by higher layer parameters CSI-AperiodicTriggerStateList and CSI-SemiPersistentOnPUSCH-TriggerStateList). Each trigger state in CSI-AperiodicTriggerStateList may contain a list of a subset of the associated CSI-ReportConfigs indicating resource set IDs for channel and optionally for interference. Each trigger state in CSI-SemiPersistentOnPUSCH-TriggerStateList may contain one or more associated CSI-ReportConfig.

Different embodiments of CSI report triggering are described herein. One or more of the embodiments herein may be combined.

In some embodiments, a CSI reporting may be triggered with reception of a non-acknowledgement or negative acknowledgment (“NACK”) corresponding to a hybrid automatic repeat request (“HARQ”) acknowledgment (“ACK”) (“HARQ-ACK”) procedure.

In various embodiments, CSI reporting is triggered with a DL grant (e.g., in DCI).

In certain embodiments, CSI reporting is triggered with a physical downlink shared channel (“PDSCH”) reception, regardless of the reception of an ACK or a NACK from a HARQ-ACK procedure.

In some embodiments, CSI reporting is triggered with UE assistance (e.g., the UE triggers the CSI report transmission).

In various embodiments, CSI reporting is triggered with a change in a parameter value in a prior CSI report (e.g., change in the CQI value). In one example, a prior CSI report is a most recent CSI report. In another example, a triggered CSI report is based on a prior CSI report. The triggered CSI report and the prior CSI report may be associated with the same CSI report setting and/or configuration (e.g., same CSI report config identifier (“ID”)). In another example, a triggered CSI report and a prior CSI report may be associated with different CSI report settings and/or configurations (e.g., different CSI report config ID) and may be linked by a common parameter configuration such as a CSI group report ID in a two CSI report setting and/or configuration. In a further example, a triggered CSI report and a prior CSI report are associated with a PDSCH reception burst (e.g., prior CSI report is a CSI report transmitted no earlier than n-x symbols from a start of a PDSCH reception burst). A PDSCH reception burst may include reception of at least one PDSCH every x slots (e.g., x=1, 2).

In certain embodiments, CSI reporting is triggered with a change in a UE position.

In some embodiments, CSI feedback may be reported over PUSCH, PUCCH, or both. Moreover, CSI feedback time-domain behavior may be aperiodic. It should be noted that periodic or semi-persistent CSI feedback are not precluded. For instance, an aperiodic CSI Report may be fed back over PUCCH.

In various embodiments, one or more CSI reports corresponding to one or more TRPs, one or more channel hypotheses, or both may be transmitted.

In certain embodiments, CSI feedback may be reported jointly (e.g., one CSI report may correspond to one or more TRPs, one or more channel hypotheses, or both). In some embodiments, CSI feedback may be reported separately (e.g., one CSI report corresponds to one TRP, one channel hypothesis, or both).

In some embodiments, one setting (e.g., CSI-ReportConfig report setting) may represent three channel hypotheses. In such embodiments, a higher layer parameter resourcesForChannelMeasurement may be for channel measurement and/or reporting, and a higher layer parameter nzp-CSI-RS-ResourcesForInterference may be for interference measurement and/or reporting. These setting may be configured in addition to a parameter that indicates multi-TRP CSI may be configured in a CSI report setting (e. g., a higher-layer parameter mTRPCSIenabled in CSI-ReportConfig report setting).

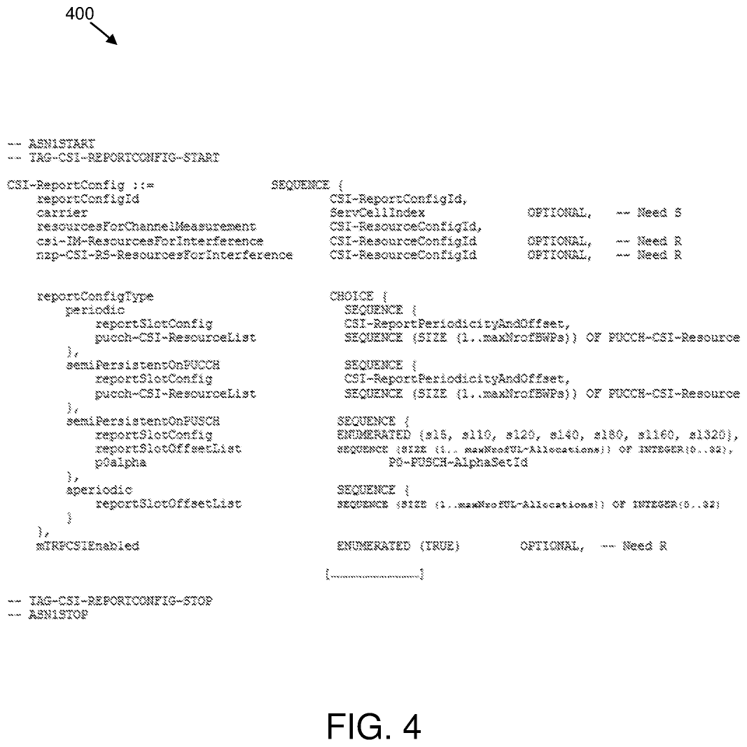

One example is given as follows: 1) hypothesis 1: single-TRP transmission from a first TRP—the parameter resourcesForChannelMeasurement corresponds to a CSI-RS from the first TRP; 2) hypothesis 2: single-TRP transmission from a second TRP—the parameter nzp-CSI-RS-ResourcesForInterference corresponds to the CSI-RS from the second TRP; and 3) hypothesis 3: multi-TRP transmission from both TRPs—the parameters resourcesForChannelMeasurement and nzp-CSI-RS-ResourcesForInterference correspond to the CSI-RS from the first and second TRPs, respectively. FIG. 4 is a diagram 400 illustrating one embodiment of abstract syntax notation (“ASN.1”) code for a CSI-ReportConfig report setting information element (“IE”).

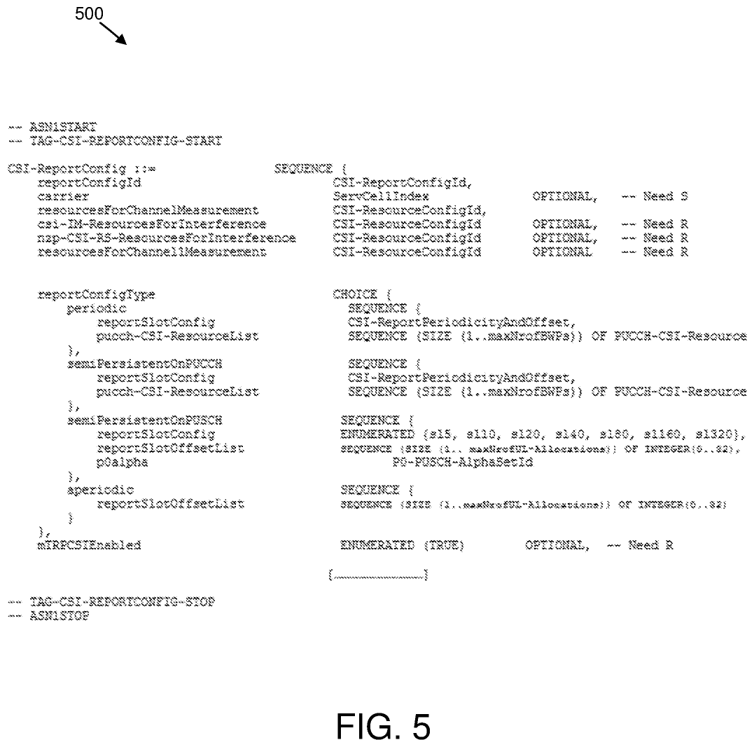

In various embodiments, one CSI-ReportConfig report setting may represent three channel hypotheses. In such embodiments, a higher layer parameter resourcesForChannelMeasurement may be for channel measurement and/or reporting, and an additional higher layer parameter may be for channel measurement and/or reporting of a second channel (e.g., resourcesForChannellMeasurement). Moreover, an additional parameter that indicates multi-TRP CSI may be configured in a CSI report setting (e.g., a higher-layer parameter mTRPCSIenabled in CSI-ReportConfig report setting). One example is given as follows: 1) hypothesis 1: single-TRP transmission from a first TRP—the parameter resourcesForChannelMeasurement corresponds to the CSI-RS from the first TRP, whereas the parameters nzp-CSI-RS-ResourcesForInterference and csi-IM-ResourcesForInterference correspond to interference measured from another TRP with non-zero power (“NZP”) CSI-RS and CSI interference measurement (“IM”) (“CSI-IM”), respectively; 2) hypothesis 2: a single-TRP transmission from a second TRP—the parameter resourcesForChannellMeasurement corresponds to the CSI-RS from the second TRP, whereas the parameters nzp-CSI-RS-ResourcesForInterference and csi-IM-ResourcesForInterference correspond to interference measured from another TRP with NZP CSI-RS and CSI-IM, respectively; and 3) hypothesis 3: multi-TRP transmission from both TRPs—the parameters resourcesForChannelMeasurement and resourcesForChannellMeasurement correspond to the CSI-RS from the first and second TRPs, respectively—the parameters nzp-CSI-RS-ResourcesForInterference and csi-IM-ResourcesForInterference correspond to interference measured from another TRP with NZP CSI-RS and CSI-IM, respectively. FIG. 5 is a diagram 500 illustrating another embodiment of ASN.1 code for a CSI-ReportConfig report setting IE.

In certain embodiments, due to different computation powers of different UEs, as well as different time requirements for reporting CSI based on an URLLC application, a UE may be limited in terms of the content of CSI feedback reported, via one or more of a CSI report setting, a UE feature list, a higher-layer configuration, or a UE-assisted indication. Different examples of capability classes are provided herein. Capability classes may include a combination of one or more of the described capabilities classes.

In some embodiments, there may be a first capability in which CSI feedback corresponding to no more than one TRP is reported under a single-TRP transmission hypothesis. In an example of this, one CSI report may include up to one PMI, and up to one CQI set.

In various embodiments, there may be a second capability in which CSI feedback corresponding to more than one TRP is reported under a single-TRP transmission hypothesis. In a first example of this, one CSI report may include up to two PMI, and up to two CQI sets. In a second example of this, up to two CSI reports may each include up to one PMI, and up to one CQI set.

In certain embodiments, there may be a third capability in which CSI feedback corresponding to more than one TRP is reported under a multi-TRP transmission hypothesis. In a first example of the third capability, one CSI report may include up to two PMI, and up to two CQI sets. In a second example, up to two CSI reports may each include up to one PMI, and up to one CQI set.

In some embodiments, there may be a fourth capability in which CSI feedback corresponding to no more than one TRP is reported under a single-TRP transmission hypothesis, in addition to more than one TRP being reported under a multi-TRP transmission hypothesis. In a first example of the fourth capability, one CSI report may include up to two PMI, and up to two CQI sets. In a second example of the fourth capability, one CSI report may include up to one PMI, and up to one CQI set, and a second CSI report may include up to two PMI, and up to two CQI sets.

In various embodiments, there may be a fifth capability in which CSI feedback corresponding to more than one TRP is reported under a single-TRP transmission hypothesis, as well as a CSI feedback corresponding to more than one TRP being reported under a multi-TRP transmission hypothesis. In a second example of the fifth capability, two CSI reports may each include up to one PMI, and up to one CQI set. In a second example of the fifth capability, one CSI report may include up to two PMI, and up to two CQI sets. In a third example of the fifth capability, two CSI reports may each include up to one PMI, and up to one CQI set, in addition to two CSI reports each including up to two PMI, and up to two CQI sets.

In certain embodiments, a UE may be configured with one or more report settings. In such embodiments, each report setting may trigger one or more CSI reports to be fed back from the UE. Moreover, the CSI reports may be ordered based on a priority function that is fixed, higher-layer configured, or based on UE assistance. Further, each CSI report may be decomposed of one or more mutually exclusive parts, and each of the parts may include a subset of one or more of each of the following components: CSI-RS resource indicator (“CRI”), synchronization signal block resource indicator (“SSBRI”), rank indicator (“RI”), PMI, i1, channel quality indicator (“CQI”), layer indicator (“LI”), L1-RSRP, and/or L1 signal to interference and noise ratio (“SINR”) (“L1-SINR”). Different embodiments of CSI feedback reporting may be made. Embodiments with a combination of one or more of other embodiments may be made.

In some embodiments, a UE may feed back only a subset of a set of CSI reports configured in one or more report settings configuring the UE based on a network configuration (e.g., a CSI report priority order).

In various embodiments, a UE may feed back only a subset of a set of CSI reports configured in one or more report settings configuring the UE based on UE assistance (e.g., UE feeding back a bitmap corresponding to or indicating the feedback and/or reported CSI reports—each bit of the bitmap corresponding to one of the CSI reports configured in the CSI report settings) (e.g., in ascending order of CSI report setting and/or config ID, in ascending order of CSI report ID for a given CSI report setting and/or config ID).

In certain embodiments, a UE may feed back only a subset of one or more parts of each CSI report in a subset of a set of CSI reports.

In some embodiments, a UE may feed back only CSI reports corresponding to a subset of a set of one or more report settings configuring the UE.

In various embodiments, each CSI report may be decomposed into one or more mutually exclusive parts, and each of the parts may include a subset of one or more of each of the following components: CRI, SSBRI, RI, PMI, i1, CQI, LI, L1-RSRP, and/or L1-SINR.

In certain embodiments, a CSI report may include CSI feedback for more than one TRP (e.g., a joint CSI report that includes up to two PMI and up to two CQI sets).

In some embodiments, a CSI report may include CSI feedback for one TRP under different channel hypotheses (e.g., the CSI Report includes two PMI, the first PMI corresponds to a first TRP under a single-TRP transmission hypothesis, and the second PMI corresponds to the first TRP under multi-TRP transmission hypothesis with a second TRP).

It should be noted that only a subset of each of one or more CSI reports may be reported after CSI triggering. For instance, only a second part of each of one or more CSI reports are fed back after CSI triggering.

In various embodiments, an indicator of reporting a subset of each of one or more CSI reports may be configured via a higher-layer parameter, medium access control (“MAC”) control element (“CE”), or indicated by a UE, where the indication by the UE may be fed back in conjunction with the HARQ-ACK feedback.

In certain embodiments, each CSI report may include one or more CQI. It should be noted that different embodiments of CQI feedback may be a combination of one or more of the other embodiments.

In some embodiments, an absolute CQI value may be reported for each CQI sub-band. In various embodiments, two sets of CQI values may be reported in one CSI report. In such embodiments, a first set of CQI values are reported in an absolute manner and a second set of CQI values may be computed in a differential manner corresponding to the first set of CQI values. It should be noted that the second set of CQI values may correspond to a different hypothesis (e.g., the first set of CQI values correspond to a codebook under a single-TRP transmission and the second set of CQI values correspond to a codebook under joint TRP transmission—one of the TRPs involved in a joint TRP transmission is also involved in a single-TRP transmission corresponding to the first set of CQI values).

In certain embodiments, one CQI value (e.g., absolute) is reported for a whole bandwidth part (“BWP”), and the CQI value corresponds to a highest CQI value across all CQI sub-bands within the BWP, and one or more sets of differential CQI values are reported for each CQI sub-band. The differential CQI values correspond to lower CQI values with respect to a highest CQI value reported for the whole BWP.

In another embodiment, one CQI value (e.g., absolute) is reported for a whole BWP. The CQI value corresponds to a lowest CQI value across all CQI sub-bands within the BWP, and one or more sets of differential CQI values are reported for each CQI sub-band. The differential CQI values correspond to higher CQI values with respect to the lowest CQI value reported for the whole BWP.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

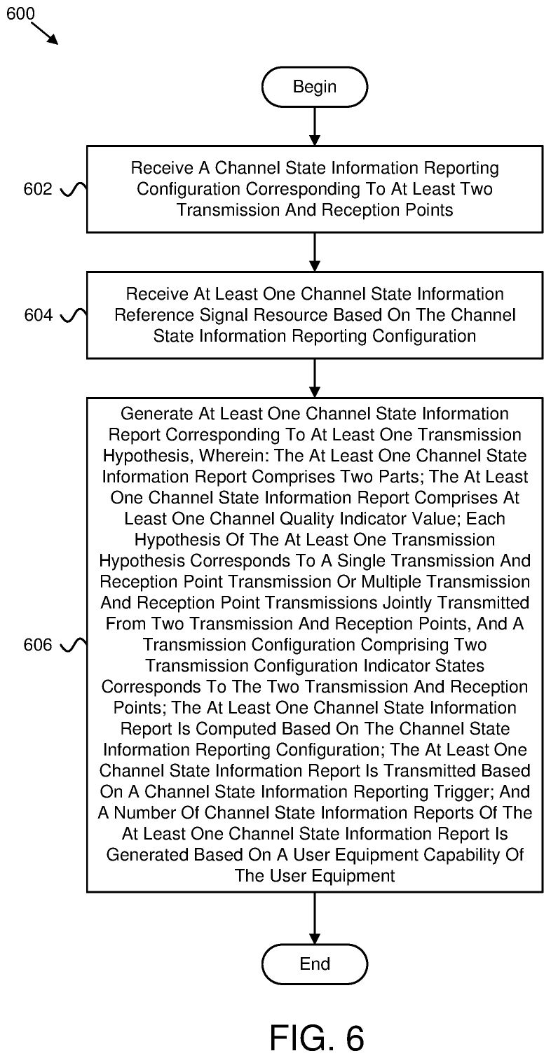

FIG. 6 is a flow chart diagram illustrating one embodiment of a method 600 for reporting channel state information based on a transmission hypothesis. In some embodiments, the method 600 is performed by an apparatus, such as the remote unit 102. In certain embodiments, the method 600 may be performed by a processor executing program code, for example, a to microcontroller, a microprocessor, a CPU, a GPU, an auxiliary processing unit, a FPGA, or the like.

In various embodiments, the method 600 includes receiving 602 a channel state information reporting configuration corresponding to at least two transmission and reception points. In some embodiments, the method 600 includes receiving 604 at least one channel state information reference signal resource based on the channel state information reporting configuration. In certain embodiments, the method 600 includes generating 606 at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

In certain embodiments: the channel state information reporting trigger comprises: receiving a non-acknowledgment of a hybrid automatic repeat request procedure; receiving an indication in a downlink control information transmission; a user equipment-assisted trigger; or some combination thereof; and the channel state information reporting trigger is based on: a change of a parameter value in the at least one channel state information report compared with a prior value of a same parameter in a prior channel state information report; a change in user equipment position with respect to a prior user equipment position estimate; or a combination thereof. In some embodiments, the channel state information reference signal resource corresponding to a first transmission and reception point of the two transmission and reception points is a non-zero power channel state information reference signal resource for channel measurement, and the channel state information reference signal resource corresponding to a second transmission and reception point of the two transmission and reception points is a non-zero power channel state information reference signal resource for interference measurement.

In various embodiments, the channel state information reference signal resource corresponding to a first transmission and reception point of the two transmission and reception points is a first non-zero power channel state information reference signal resource for channel measurement, and the channel state information reference signal resource corresponding to a second transmission and reception point of the two transmission and reception points is a second non-zero power channel state information reference signal resource for channel measurement. In one embodiment, a channel state information report corresponding to a multiple transmission and reception point hypothesis comprises up to two precoding matrix indicators. In certain embodiments, the method 600 further comprises generating a maximum of one channel state information report corresponding to a multiple transmission and reception point hypothesis.

In some embodiments, the method 600 further comprises generating a maximum of one channel state information report corresponding to a multiple transmission and reception point hypothesis and one channel state information report corresponding to a single transmission and reception point hypothesis. In various embodiments, the method 600 further comprises generating a maximum of one channel state information report corresponding to a multiple transmission and reception point hypothesis and generating a maximum of two channel state information reports corresponding to a single transmission and reception point hypothesis. In one embodiment, the method 600 further comprises reporting a subset of the at least one channel state information report, wherein the subset is determined based on a network configuration, user equipment assistance, or a combination thereof.

In certain embodiments, the subset comprises one part of the two parts of the at least one channel state information report, a subset of the channel state information reports of the at least one channel state information report, or some combination thereof. In some embodiments, only a second part of the two parts of the at least one channel state information report is reported after channel state information report triggering. In various embodiments, the at least one channel quality indicator value corresponds to absolute values for each subband of a channel.

In one embodiment, the method 600 further comprises reporting one absolute channel quality indicator value that corresponds to maximum channel quality indicator values or minimum channel quality indicator values corresponding to all subbands, and wherein one differential channel quality indicator value is reported for each subband with respect to the one absolute channel quality indicator value.

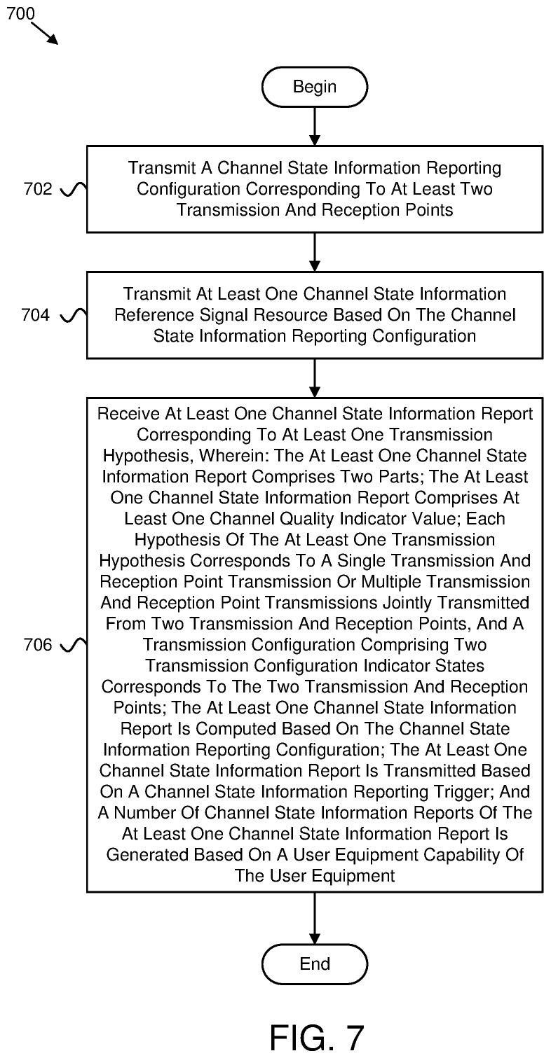

FIG. 7 is a flow chart diagram illustrating another embodiment of a method 700 for reporting channel state information based on a transmission hypothesis. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes transmitting 702 a channel state information reporting configuration corresponding to at least two transmission and reception points. In some embodiments, the method 700 includes transmitting 704 at least one channel state information reference signal resource based on the channel state information reporting configuration. In certain embodiments, the method 700 includes receiving 706 at least one channel state information report corresponding to at least one transmission hypothesis. The at least one channel state information report includes two parts; the at least one channel state information report includes at least one channel quality indicator value; each hypothesis of the at least one transmission hypothesis corresponds to a single transmission and reception point transmission or multiple transmission and reception point transmissions jointly transmitted from two transmission and reception points, and a transmission configuration including two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

In certain embodiments: the channel state information reporting trigger comprises: receiving a non-acknowledgment of a hybrid automatic repeat request procedure; receiving an indication in a downlink control information transmission; a user equipment-assisted trigger; or some combination thereof; and the channel state information reporting trigger is based on: a change of a parameter value in the at least one channel state information report compared with a prior value of a same parameter in a prior channel state information report; a change in user equipment position with respect to a prior user equipment position estimate; or a combination thereof. In some embodiments, the channel state information reference signal resource corresponding to a first transmission and reception point of the two transmission and reception points is a non-zero power channel state information reference signal resource for channel measurement, and the channel state information reference signal resource corresponding to a second transmission and reception point of the two transmission and reception points is a non-zero power channel state information reference signal resource for interference measurement.

In various embodiments, the channel state information reference signal resource corresponding to a first transmission and reception point of the two transmission and reception points is a first non-zero power channel state information reference signal resource for channel measurement, and the channel state information reference signal resource corresponding to a second transmission and reception point of the two transmission and reception points is a second non-zero power channel state information reference signal resource for channel measurement. In one embodiment, a channel state information report corresponding to a multiple transmission and reception point hypothesis comprises up to two precoding matrix indicators.

In one embodiment, a method of a user equipment comprises: receiving a channel state information reporting configuration corresponding to at least two transmission and reception points; receiving at least one channel state information reference signal resource based on the channel state information reporting configuration; and generating at least one channel state information report corresponding to at least one transmission hypothesis, wherein: the at least one channel state information report comprises two parts; the at least one channel state information report comprises at least one channel quality indicator value; each hypothesis of the at least one transmission hypothesis corresponds to a single transmission and reception point transmission or multiple transmission and reception point transmissions jointly transmitted from two transmission and reception points, and a transmission configuration comprising two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

In certain embodiments: the channel state information reporting trigger comprises: receiving a non-acknowledgment of a hybrid automatic repeat request procedure; receiving an indication in a downlink control information transmission; a user equipment-assisted trigger; or some combination thereof; and the channel state information reporting trigger is based on: a change of a parameter value in the at least one channel state information report compared with a prior value of a same parameter in a prior channel state information report; a change in user equipment position with respect to a prior user equipment position estimate; or a combination thereof.

In some embodiments, the channel state information reference signal resource corresponding to a first transmission and reception point of the two transmission and reception points is a non-zero power channel state information reference signal resource for channel measurement, and the channel state information reference signal resource corresponding to a second transmission and reception point of the two transmission and reception points is a non-zero power channel state information reference signal resource for interference measurement.

In various embodiments, the channel state information reference signal resource corresponding to a first transmission and reception point of the two transmission and reception points is a first non-zero power channel state information reference signal resource for channel measurement, and the channel state information reference signal resource corresponding to a second transmission and reception point of the two transmission and reception points is a second non-zero power channel state information reference signal resource for channel measurement.

In one embodiment, a channel state information report corresponding to a multiple transmission and reception point hypothesis comprises up to two precoding matrix indicators.

In certain embodiments, the method further comprises generating a maximum of one channel state information report corresponding to a multiple transmission and reception point hypothesis.

In some embodiments, the method further comprises generating a maximum of one channel state information report corresponding to a multiple transmission and reception point hypothesis and one channel state information report corresponding to a single transmission and reception point hypothesis.

In various embodiments, the method further comprises generating a maximum of one channel state information report corresponding to a multiple transmission and reception point hypothesis and generating a maximum of two channel state information reports corresponding to a single transmission and reception point hypothesis.

In one embodiment, the method further comprises reporting a subset of the at least one channel state information report, wherein the subset is determined based on a network configuration, user equipment assistance, or a combination thereof.

In certain embodiments, the subset comprises one part of the two parts of the at least one channel state information report, a subset of the channel state information reports of the at least one channel state information report, or some combination thereof.

In some embodiments, only a second part of the two parts of the at least one channel state information report is reported after channel state information report triggering.

In various embodiments, the at least one channel quality indicator value corresponds to absolute values for each subband of a channel.

In one embodiment, the method further comprises reporting one absolute channel quality indicator value that corresponds to maximum channel quality indicator values or minimum channel quality indicator values corresponding to all subbands, and wherein one differential channel quality indicator value is reported for each subband with respect to the one absolute channel quality indicator value.

In one embodiment, an apparatus comprises a user equipment. The apparatus further comprises: a receiver that: receives a channel state information reporting configuration corresponding to at least two transmission and reception points; and receives at least one channel state information reference signal resource based on the channel state information reporting configuration; and a processor that generates at least one channel state information report corresponding to at least one transmission hypothesis, wherein: the at least one channel state information report comprises two parts; the at least one channel state information report comprises at least one channel quality indicator value; each hypothesis of the at least one transmission hypothesis corresponds to a single transmission and reception point transmission or multiple transmission and reception point transmissions jointly transmitted from two transmission and reception points, and a transmission configuration comprising two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

In certain embodiments: the channel state information reporting trigger comprises: receiving a non-acknowledgment of a hybrid automatic repeat request procedure; receiving an indication in a downlink control information transmission; a user equipment-assisted trigger; or some combination thereof; and the channel state information reporting trigger is based on: a change of a parameter value in the at least one channel state information report compared with a prior value of a same parameter in a prior channel state information report; a change in user equipment position with respect to a prior user equipment position estimate; or a combination thereof.

In some embodiments, the channel state information reference signal resource corresponding to a first transmission and reception point of the two transmission and reception points is a non-zero power channel state information reference signal resource for channel measurement, and the channel state information reference signal resource corresponding to a second transmission and reception point of the two transmission and reception points is a non-zero power channel state information reference signal resource for interference measurement.

In various embodiments, the channel state information reference signal resource corresponding to a first transmission and reception point of the two transmission and reception points is a first non-zero power channel state information reference signal resource for channel measurement, and the channel state information reference signal resource corresponding to a second transmission and reception point of the two transmission and reception points is a second is non-zero power channel state information reference signal resource for channel measurement.

In one embodiment, a channel state information report corresponding to a multiple transmission and reception point hypothesis comprises up to two precoding matrix indicators.

In certain embodiments, the processor generates a maximum of one channel state information report corresponding to a multiple transmission and reception point hypothesis.

In some embodiments, the processor generates a maximum of one channel state information report corresponding to a multiple transmission and reception point hypothesis and one channel state information report corresponding to a single transmission and reception point hypothesis.

In various embodiments, the processor generates a maximum of one channel state information report corresponding to a multiple transmission and reception point hypothesis and generating a maximum of two channel state information reports corresponding to a single transmission and reception point hypothesis.

In one embodiment, the apparatus further comprises a transmitter that reports a subset of the at least one channel state information report, wherein the subset is determined based on a network configuration, user equipment assistance, or a combination thereof.

In certain embodiments, the subset comprises one part of the two parts of the at least one channel state information report, a subset of the channel state information reports of the at least one channel state information report, or some combination thereof.

In some embodiments, only a second part of the two parts of the at least one channel state information report is reported after channel state information report triggering.

In various embodiments, the at least one channel quality indicator value corresponds to absolute values for each subband of a channel.

In one embodiment, the apparatus further comprises a transmitter that reports one absolute channel quality indicator value that corresponds to maximum channel quality indicator values or minimum channel quality indicator values corresponding to all subbands, and wherein one differential channel quality indicator value is reported for each subband with respect to the one absolute channel quality indicator value.

In one embodiment, a method of a network device comprises: transmitting a channel state information reporting configuration corresponding to at least two transmission and reception points; transmitting at least one channel state information reference signal resource based on the channel state information reporting configuration; and receiving at least one channel state information report corresponding to at least one transmission hypothesis, wherein: the at least one channel state information report comprises two parts; the at least one channel state information report comprises at least one channel quality indicator value; each hypothesis of the at least one transmission hypothesis corresponds to a single transmission and reception point transmission or multiple transmission and reception point transmissions jointly transmitted from two transmission and reception points, and a transmission configuration comprising two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

In certain embodiments: the channel state information reporting trigger comprises: receiving a non-acknowledgment of a hybrid automatic repeat request procedure; receiving an indication in a downlink control information transmission; a user equipment-assisted trigger; or some combination thereof; and the channel state information reporting trigger is based on: a change of a parameter value in the at least one channel state information report compared with a prior value of a same parameter in a prior channel state information report; a change in user equipment position with respect to a prior user equipment position estimate; or a combination thereof.

In some embodiments, the channel state information reference signal resource corresponding to a first transmission and reception point of the two transmission and reception points is a non-zero power channel state information reference signal resource for channel measurement, and the channel state information reference signal resource corresponding to a second transmission and reception point of the two transmission and reception points is a non-zero power channel state information reference signal resource for interference measurement.

In various embodiments, the channel state information reference signal resource corresponding to a first transmission and reception point of the two transmission and reception points is a first non-zero power channel state information reference signal resource for channel measurement, and the channel state information reference signal resource corresponding to a second transmission and reception point of the two transmission and reception points is a second non-zero power channel state information reference signal resource for channel measurement.

In one embodiment, a channel state information report corresponding to a multiple transmission and reception point hypothesis comprises up to two precoding matrix indicators.

In one embodiment, an apparatus comprises a network device. The apparatus further comprises: a transmitter that: transmits a channel state information reporting configuration corresponding to at least two transmission and reception points; and transmits at least one channel state information reference signal resource based on the channel state information reporting configuration; and a receiver that receives at least one channel state information report corresponding to at least one transmission hypothesis, wherein: the at least one channel state information report comprises two parts; the at least one channel state information report comprises at least one channel quality indicator value; each hypothesis of the at least one transmission hypothesis corresponds to a single transmission and reception point transmission or multiple transmission and reception point transmissions jointly transmitted from two transmission and reception points, and a transmission configuration comprising two transmission configuration indicator states corresponds to the two transmission and reception points; the at least one channel state information report is computed based on the channel state information reporting configuration; the at least one channel state information report is transmitted based on a channel state information reporting trigger; and a number of channel state information reports of the at least one channel state information report is generated based on a user equipment capability of the user equipment.

In certain embodiments: the channel state information reporting trigger comprises: receiving a non-acknowledgment of a hybrid automatic repeat request procedure; receiving an indication in a downlink control information transmission; a user equipment-assisted trigger; or some combination thereof; and the channel state information reporting trigger is based on: a change of a parameter value in the at least one channel state information report compared with a prior value of a same parameter in a prior channel state information report; a change in user equipment position with respect to a prior user equipment position estimate; or a combination thereof.

In some embodiments, the channel state information reference signal resource corresponding to a first transmission and reception point of the two transmission and reception points is a non-zero power channel state information reference signal resource for channel measurement, and the channel state information reference signal resource corresponding to a second transmission and reception point of the two transmission and reception points is a non-zero power channel state information reference signal resource for interference measurement.

In various embodiments, the channel state information reference signal resource corresponding to a first transmission and reception point of the two transmission and reception points is a first non-zero power channel state information reference signal resource for channel measurement, and the channel state information reference signal resource corresponding to a second transmission and reception point of the two transmission and reception points is a second non-zero power channel state information reference signal resource for channel measurement.

In one embodiment, a channel state information report corresponding to a multiple transmission and reception point hypothesis comprises up to two precoding matrix indicators.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a user equipment (UE), the method comprising:
receiving a channel state information (CSI) reporting configuration corresponding to at least two transmission and reception points (TRPs);
receiving a CSI reference signal (CSI-RS) based on the CSI reporting configuration; and
generating a CSI report corresponding to at least one transmission hypothesis, wherein the at least one transmission hypothesis corresponds to a single TRP transmission or multiple TRP transmissions from multiple TRPs, and wherein the CSI report is based on the CSI reporting configuration.

2. The method of claim 16, wherein:
the CSI reporting trigger comprises:
receiving a non-acknowledgment (NACK) of a hybrid automatic repeat request (HARD) procedure;
receiving an indication in a downlink control information (DCI);
a UE-assisted trigger;
or a combination thereof; and
the CSI reporting trigger is based on:
a change of a parameter value in the CSI report compared with a prior value of a same parameter in a prior CSI report;
a change in a position of the UE with respect to a prior position estimate of the UE;
or a combination thereof.

3. (canceled)

4. The method of claim 1, wherein the CSI-RS corresponding to a first TRP of the multiple TRPs is associated with a first non-zero power CSI-RS (NZP CSI-RS) resource for channel measurement, and the CSI-RS corresponding to a second TRP of the multiple TRPs is associated with a second NZP CSI-RS resource for channel measurement.

5. The method of claim 1, wherein the CSI report comprises one or more components comprising a CSI-RS resource indicator (CRI), a rank indicator (RI), a precoding matrix indicator (PMI), a channel quality indicator (CQI), or a combination thereof.

6. (canceled)

7. (canceled)

8. (canceled)

9. The method of claim 19, further comprising:
reporting a subset of the CSI report,
wherein the subset is based on a network configuration, UE assistance information, or a combination thereof.

10. The method of claim 9, wherein the subset comprises the CSI part 1, the CSI part 2, or a subset of a set of CSI reports, or a combination thereof.

11. The method of claim 9, further comprising:
transmitting exclusively the CSI part 2 after a CSI report triggering.

12. The method of claim 1, wherein the CSI report comprises a channel quality indicator (CQI) value, and wherein the CQI value corresponds to an absolute value for each subband of a channel.

13. The method of claim 1, further comprising:
reporting one absolute channel quality indicator (CQI) value that corresponds to maximum CQI value or minimum CQI values corresponding to subbands, wherein one differential CQI value is reported for each subband with respect to the one absolute CQI value.

14. An apparatus comprising:
a memory; and
a processor coupled to the memory, the processor configured to cause the apparatus to:
receive a channel state information (CSI) reporting configuration corresponding to at least two transmission and reception points (TRPs); and
receive a CSI reference signal (CSI-RS) based on the CSI reporting configuration; and
generate a CSI report corresponding to at least one transmission hypothesis, wherein the at least one transmission hypothesis corresponds to a single TRP transmission or multiple TRP transmissions from multiple TRPs, and wherein the CSI report is based on the CSI reporting configuration.

15. An apparatus comprising:
a memory; and
a processor coupled to the memory, the processor configured to cause the apparatus to:
transmit a channel state information (CSI) reporting configuration corresponding to at least two transmission and reception points (TRPs); and
transmit a CSI reference signal (CSI-RS) based on the CSI reporting configuration; and
receive a CSI report corresponding to at least one transmission hypothesis, wherein the at least one transmission hypothesis corresponds to a single TRP transmission or multiple TRP transmissions from multiple TRPs, and wherein the CSI report is based on the CSI reporting configuration.

16. The method of claim 1, further comprising transmitting the generated CSI report based on a CSI reporting trigger.

17. The method of claim 5, wherein each of the one or more components is associated with a transmission hypothesis of the at least one transmission hypothesis.

18. The method of claim 1, wherein the at least one transmission hypothesis comprises:
a first transmission hypothesis corresponding to a transmission from a first TRP;
a second transmission hypothesis corresponding to a transmission from a second TRP; and
a third transmission hypothesis corresponding to a joint transmission from the first TRP and the second TRP.

19. The method of claim 1, wherein the CSI report comprises a CSI part 1 and a CSI part 2.

20. The apparatus of claim 14, wherein the instructions are further executable by the processor to cause the apparatus to transmit the generated CSI report based on a CSI reporting trigger.

21. The apparatus of claim 14, wherein the CSI report comprises one or more components comprising a CSI-RS resource indicator (CRI), a rank indicator (RI), a precoding matrix indicator (PMI), a channel quality indicator (CQI), or a combination thereof.

22. The apparatus of claim 21, wherein each of the one or more components is associated with a transmission hypothesis of the at least one transmission hypothesis.

23. The apparatus of claim 14, wherein the at least one transmission hypothesis comprises:
a first transmission hypothesis corresponding to a transmission from a first TRP;
a second transmission hypothesis corresponding to a transmission from a second TRP; and
a third transmission hypothesis corresponding to a joint transmission from the first TRP and the second TRP.

24. The apparatus of claim 14, wherein the CSI report comprises a CSI part 1 and a CSI part 2.
